(19) United States
(12) Patent Application Publication
(10) Pub. No.: US 2004/0091105 A1
(43) Pub. Date: May 13, 2004

(54) Apparatus for hyperelliptic-curve cryptography processing

(76) Inventors: Ho Won Kim, Daejeon (KR); Yong-Je Choi, Gwangju (KR); Moo Seop Kim, Daejeon (KR); Heui Su Ryu, Daejeon (KR)

Correspondence Address: JACOBSON HOLMAN PLLC, 400 SEVENTH STREET N.W., SUITE 600, WASHINGTON, DC, 20004, US

(21) Appl. No.: 10/385,671

(22) Filed: Mar. 12, 2003

(30) Foreign Application Priority Data
Nov. 8, 2002 (KR) 10-2002-0069061

(51) Int. Cl. H04K 1/00

(52) U.S. Cl. 380/30

(57) ABSTRACT

In an apparatus for a hyperelliptic-curve cryptography processing, an input/output control block controls a peripheral component interconnect (PCI) interface block, a direct memory access (DMA) and a data input/output. An input memory block stores an external instruction and input data provided by the PCI interface block. An output memory block stores a final and an intermediate value of a hyperelliptic-curve cryptography operation. A MUX controls a path of input/output data. An operation core block performs a genus one elliptic-curve and a genus two hyperelliptic-curve cryptography algorithm, respectively. A controlling device controls the operation core block.

### FIELD OF THE INVENTION

The present invention relates to an apparatus for a hyperelliptic-curve cryptography processing; and, more particularly, to the apparatus for the hyperelliptic-curve cryptography processing, which is suitable for processing a genus one elliptic-curve and a genus two hyperelliptic-curve cryptography algorithm at a high speed.

### BACKGROUND OF THE INVENTION

As most of the conventional public key cryptography processors, an RAS cryptography processor and an elliptic-curve cryptography processor are used.

The elliptic-curve cryptography processor has a polynomial basis in a Galois field, but can process only a minimal polynomial. Accordingly, the elliptic-curve cryptography processor can effectively process only corresponding elliptic-curve cryptography algorithms but not other elliptic-curve cryptography algorithms.

Meanwhile, the RSA cryptography processor is based on an exponential operation, and therefore a cryptography processor using the RSA cryptographic scheme requires long key length. More specifically, a length of key is required to be 1024-bit or 2048-bit in order to provide an enough high level of security. Therefore, the RSA cryptographic scheme is not suitable for mobile devices such as a cellular phone, a PDA and a smart card due to constraint memory resources and power consumption which are caused by long key length requirement.

Consequently, such processors are not usable in an embedded system having constraint resources and hardly applicable to other fields due to narrow applicable scopes.

### SUMMARY OF THE INVENTION

It is, therefore, a primary object of the present invention to provide an apparatus for a hyperelliptic-curve cryptography processing, which is capable of a high speed processing on a genus one elliptic-curve and a genus two hyperelliptic-curve cryptography algorithm.

It is another object of the present invention to provide an apparatus for a hyperelliptic-curve cryptography processing, which reduces a hardware complexity by sharing hardware for use in a hyperelliptic-curve cryptosystem.

In accordance with the present invention, there is provided an apparatus for a hyperelliptic-curve cryptography processing, including: an input/output control block for controlling a peripheral component interconnect (PCI) interface block, a direct memory access (DMA) and data input/output; an input memory block for storing external instructions and input data provided by the PCI interface block; an output memory block for storing a final and an intermediate value of a hyperelliptic-curve cryptography operation; a MUX for controlling a path of input/output data of the input and the output memory blocks; an operation core block for performing a genus one elliptic-curve cryptography algorithm and the genus two hyperelliptic-curve cryptography algorithm depending on the external instructions and the input data provided by the MUX; and a control device for controlling the operation core block depending on instructions transmitted from the input memory block.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram for illustrating an apparatus for a hyperelliptic-curve cryptography processing in accordance with a preferred embodiment of the present invention;

FIG. 2 describes a detailed block diagram for showing an operation core block of the apparatus for the hyperelliptic-curve cryptography processing of FIG. 1;

FIG. 3 provides a block diagram for describing an adder-shifter used in a multiplication block and an inverse and greatest common divisor computation block of FIG. 2; and

FIG. 4 presents a block diagram for showing a pre-calculation and selection operator used in the operation core block of FIG. 2.

### DETAILED DESCRIPTION OF THE PREFERRED EMBODIMENTS

Hereinafter, preferred embodiments of the present invention will be described in detail with reference to the accompanying drawings.

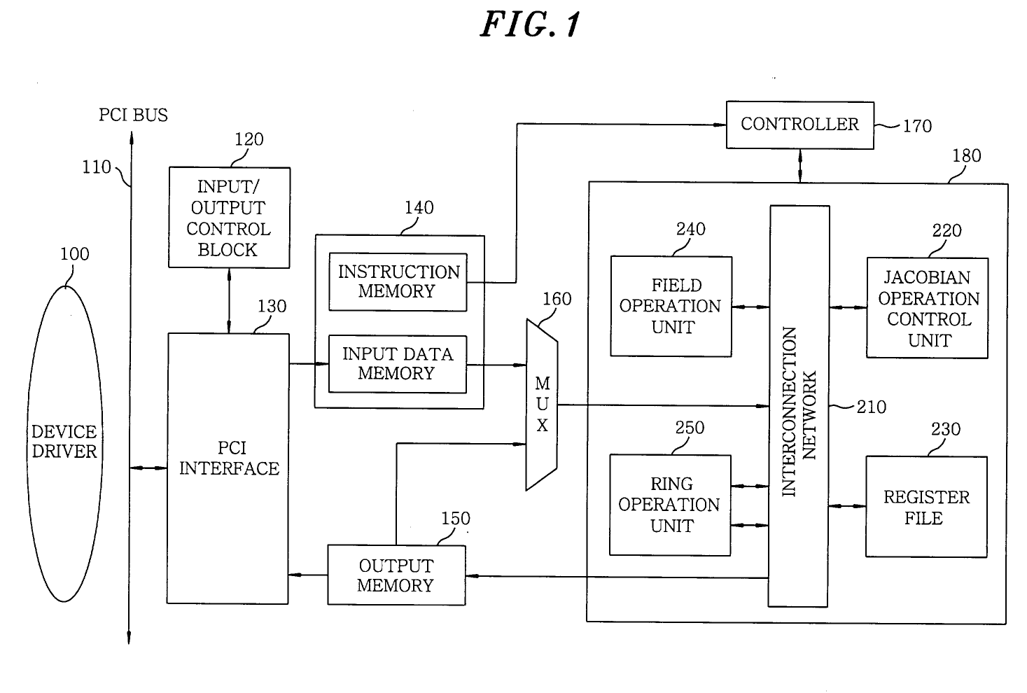

A hyperelliptic-curve cryptography processor illustrated in FIG. 1 is connected to a device driver 100 of an external system and internally has a PCI interface 130. Therefore, the hyperelliptic-curve cryptography processor can be applied to every system having a PCI bus 110 through the PCI interface 130.

The apparatus of the present invention includes an input/output control block 120 for controlling a direct memory access (DMA) and input/output data, a PCI interface block 130, an input memory block 140 for storing an external instruction and input data, an output memory 150 for storing a final or an intermediate value of the encryption core block 180, a MUX 160 for controlling a path of input/output data, a controller 170 and an operation core block 180.

The device driver 100 enables an external application system to recognize the hyperelliptic-curve cryptography processor. For a window operating system, the device driver 100 may be a VxD or WDM driver. The hyperelliptic-curve cryptography processor in accordance with the present invention interfaces through a PCI bus 110. The external application system is able to send an instruction to the hyperelliptic-curve cryptography processor by the device driver 100. Further, it is possible to input/output data and transmit an interrupt signal.

The PCI interface 130 of the hyperelliptic-curve cryptography processor analyzes a PCI instruction and a data transaction of a host system where the hyperelliptic-curve cryptography processor is used and appropriately communicates with the host system, wherein the PCI interface 130 thereof includes a PCI configuration register, a target mode controller and a master mode controller. In a master mode, the PCI interface 130 may be operated with the input/output control block 120 to carry out a DMA transmission.

The input memory block 140 is used for receiving and storing instructions and data of the hyperelliptic-curve cryptography processor in accordance with the present invention, wherein the instructions and the data are distinguished by addresses thereof.

The output memory block 150 stores a final and an intermediate value of operations of the hyperelliptic-curve cryptography processor. After the PCI interface 130 sends an interrupt signal to the host system, the final result of the operation is transmitted to an application system. And then, data of the output memory block 150 is inputted iteratively into the operation core block 180 through the MUX 160.

The controller 170 controls the operation core block 180 according to the instructions transmitted from the input memory block 140. The controller 170 analyzes the inputted instructions and outputs control signals for the inputted instructions to an operation core block 180.

The operation core block 180 includes operational components required for performing a high speed processing on the genus one elliptic-curve and the genus two hyperelliptic-curve cryptography algorithm, wherein the operational components has an interconnection network 210, a Jacobian operation control unit 220, a register file 230, a field operation unit 240 and a ring operation unit 250, which perform a desired field operation, ring operation, divisor operation and scalar operation.

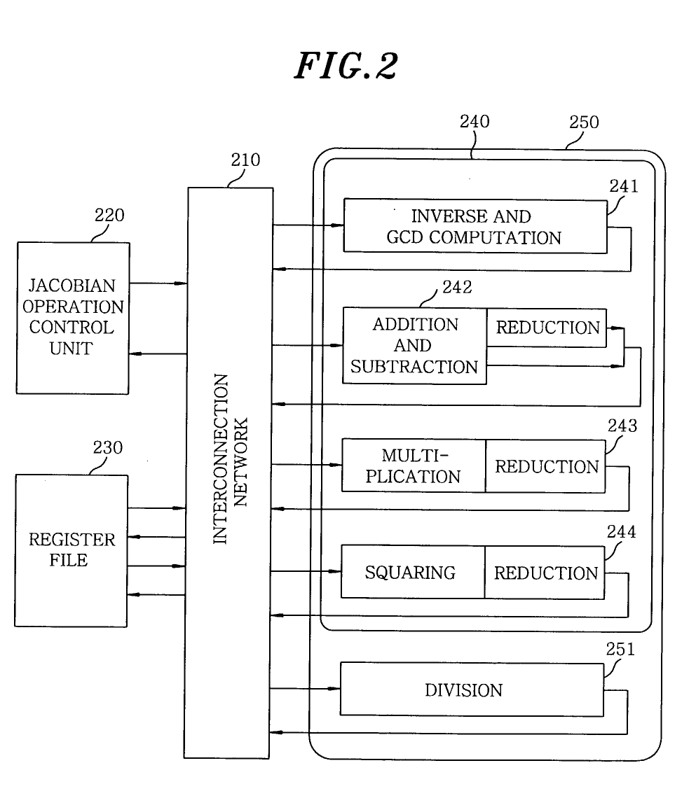

The operation core block 180 will be described in detail with reference to FIG. 2.

Referring to FIG. 2, the operation core block 180 includes an inverse and greatest common divisor (GCD) operation block 241, an addition and subtraction block 242, a multiplication-reduction block 243, a squaring-reduction block 244 in the field operation unit 240 and further includes a division block 251 for the ring operation unit 250.

Such operational components are interconnected by the high performance many-to-many interconnection network 210, and the operations thereof are controlled by the external controller 170 and the Jacobian operation control unit 220. Input data for an operation and an intermediate result of the operation are stored in the register file 230. Each of the inverse and GCD computation block 241 and the division block 251 in the ring operation unit 250 is constructed by a pipeline structure for obtaining a high-speed operation. The rest of the operational components, i.e., the addition and subtraction block 242, the multiplication-reduction block 243 and the squaring-reduction block, may be constructed by multiple structures in order to improve a performance of the hyperelliptic-curve cryptography processor.

Meanwhile, an addition and a doubling of a devisor can be executed by using the above-described operational components without using additional components.

A hyperelliptic-curve cryptography processing is performed based on scalar multiplication and further the scalar multiplication is carried out by the addition and the doubling of divisors. The controller 170 controls a data path of the field and the ring operation unit in accordance with the present invention to thereby perform the GCD computation, the division, the squaring, the modular operation, the addition and the subtraction.

The addition and the doubling of the divisors are implemented by using a ‘Cantor’ algorithm, which includes a composition step and a reduction step. The reduction step can be implemented by a Gauss reduction or a Lagrange reduction.

An operation of the addition and subtraction block 242 is simply implemented by an Exclusive OR (XOR) operation in a field and a ring operation unit 240 and 250 if the field and the ring have characteristic 2. The field and ring operations are distinguished by input/output data type thereof. The input/output of the addition and subtraction block 242 corresponds to a bit stream value in the field operation and a field element value in the ring operation. Further, since addition and subtraction do not require a clock signal for processing, the addition and subtraction block 242 may be used with other operational components, e.g., the multiplication block, the squaring block and the like, for other processing. The Jacobian operation unit 220 controls the interconnection network 210 to realize the sharing of the addition and subtraction block 242.

The multiplication-reduction block 243 can be shared in the field operation unit 240 and the ring operation unit 250 in hardware aspect as in the aforementioned the addition and subtraction block 242. The field operation and the ring operation for multiplication are distinguished based on an input/output value thereof, and the register file 230 and the Jacobian operation control unit 220 control both of the operations. While multiplication requires a plurality of clock cycles for computing, a final and an intermediate value of multiplication are outputted from a reduction circuit that does not require clock cycle to process.

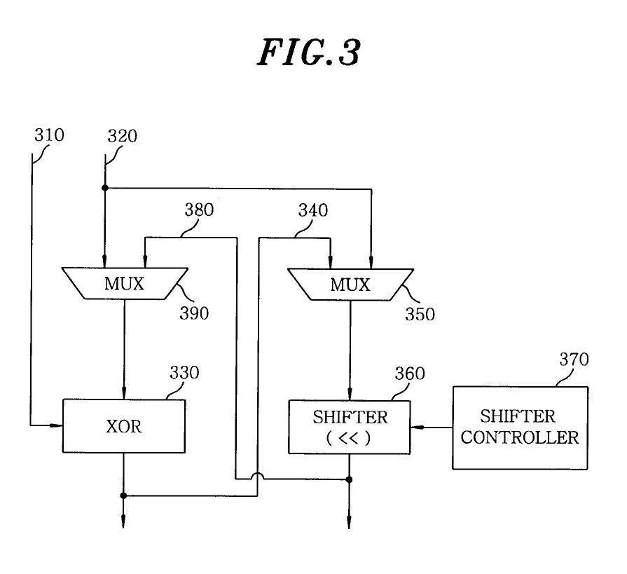

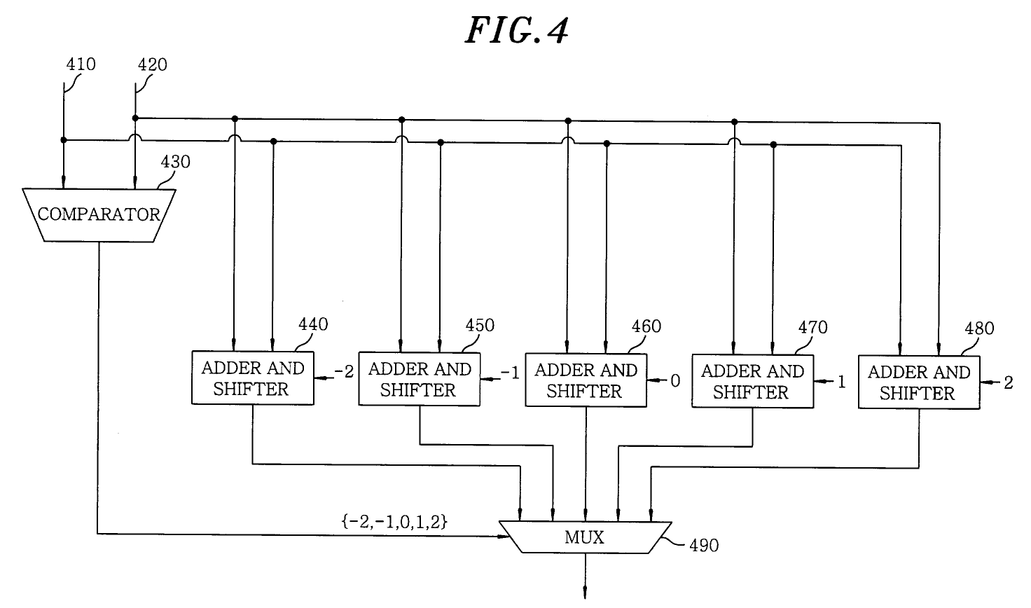

The inverse and GCD computation block 241 is differently used in the field and the ring operation, respectively. While the field operation requires an inverse computation, the ring operation demands a GCD computation. An inverse and a GCD are computed by using an Extended Euclidean Algorithm (EEA) in the present invention. In order to increase an operational speed, an ‘adder-shifter’ shown in FIG. 3 and a ‘pre-calculation-selection operator’ shown in FIG. 4 can be used in the inverse and GCD computation block 241.

Further, since the inverse and GCD computation requires a plurality of clock cycles for processing, a pipeline register can be added to the cryptosystem for enabling parallel processing in a scalar multiplication, which is required for the inverse and GCD computation.

A structure of the squaring-reduction block 244 is similar to that of the multiplication-reduction block 243.

The division block 251, which is needed only in the ring operation, requires both a quotient and a remainder, unlike an inverse computation in the field operation, so that it is difficult to perform division at high speed. Thus, the division block 251 in accordance with the present invention employs pipeline structures in order to provide a high speed and parallel processing.

As simply described above, the operational components in the operation core block 180 are interconnected through the high performance many-to-many interconnection network 210. In comparison with a one-to-one communication method, the many-to-many interconnection network 210 is capable of simultaneous communication of plural messages between different the operational components, thereby increasing a manipulation of an available bandwidth between the operational components. The interconnection network 210 in accordance with the present invention uses a multi-stage interconnection network (MIN) or a mesh interconnection network for the many-to-many interconnection.

The Jacobian operation control unit 220 performs an operation on divisors, that is, a core operation of the hyperelliptic-curve cryptosystem. For the addition and doubling of divisors, every operational component of the field and the ring operation is required. Therefore, the Jacobian operation control unit 220 controls the aforementioned operational components, i.e., the field operation unit 240 and the ring operation unit 250, the interconnection network 210 and the register file 230.

The register file 230 stores input data to be processed and intermediate data of the operations. And also, the register file 230 has a structure accommodating variable length data to be used in both the field and the ring operation.

FIG. 3 depicts the adder-shifter for performing operations of ‘(A+B)<<C’ and ‘A+(B<<C)’ at a high speed. The adder-shifter can be used for the multiplication in the field and ring operations and for the inverse computation in the field operation. Thus, a structural efficiency in hardware can be improved by sharing the adder-shifter for both of the operations.

In FIG. 3, the Jacobian operation control unit 220 of the present invention can control a path of MUXs 390 and 350 to operate ‘(A+B)<<C’ and ‘A+(B<<C)’ selectively.

The operation of ‘(A+B)<<C’ is processed as follows. Input signals A 310 and B 320 are inputted into an XOR block 330. Next, an output of the XOR block 330 passes through the MUX 350 and then is shifted by a shifter 360 by a shifting bit C. Herein, a shift controller 370 determines the shifting bit C. A barrel shifter can be used as the shifter 360 of the present invention, and therefore a certain bit can be shifted during one clock cycle.

In order to perform the operation of ‘A+(B<<C)’, an input signal A 310 is inputted into the XOR block 330 and an input signal B 320 passes through the MUX 350. The input signal B 320 transmitted from the MUX 350 is inputted into the shifter 360, and then the signal is shifted by a shifting bit C. The shifted signal 380 passes through the MUX 390. Thereafter, a result value from the MUX 390 is inputted into the XOR block 330.

For the above hardware, if the MUXs 350 and 390 are implemented by complex structures, an effect of sharing components is reduced. Thus, it is preferable to implement the MUXs 350 and 390 by using a pass-transistor to maximize the sharing effect.

The shifter controller 370 controls a connection state of the shifter 360, i.e., the barrel shifter, and determines the certain bits to be shifted. Further, the shifter controller 370 is used in an EEA algorithm for performing a field multiplication, a ring multiplication and an inverse computation in the field operation.

FIG. 4 presents a structure diagram of a ‘pre-calculation-selection operator’ for effectively performing operations, i.e., GCD computation, inverse computation and the like, required for operating a hyperelliptic-curve cryptography algorithm. By using such hardware, comparison, determination and computation for the hyperelliptic-curve cryptography algorithm of the present invention may be operated in parallel, so that a delay time is reduced to obtain a high operational speed.

Referring to FIG. 4, there are illustrated five adder-shifter circuits 440 to 480. Since the EEA algorithm for calculating a GCD employs ordinarily characteristic value (degree difference) of 2, there may be 5 different values, i.e., −2, −1, 0, 1 and 2, representing the difference between degrees. Therefore, the circuits have a hardware structure for processing the five difference values in parallel, wherein each adder-shifter processes for the respective value.

Further, the pipeline registers are added to an inverse and GCD computation circuit which requires multiple clock cycles to compute, wherein the pipeline registers are located on an input end of a MUX 490 of FIG. 4, where a delay time of the comparator 430 can be minimized, thereby providing a high speed and parallel processing.

The delay time is ordinarily increased due to multiple stage logics employed in the comparator 430. In order to increase an operational speed by reducing the delay time, comparison, addition and shifting should be performed in parallel. And also, after comparison, a selection of final value of the above operations can be made to increase the operational speed. Further, by adding the pipeline registers, the operational speed is accelerated and scalar multiplication can be computed in parallel.

The above-described hyperelliptic-curve cryptography processor in accordance with the present invention has following advantages.

First, the hyperelliptic-curve cryptography processor provides high level of security with a short key length and can harness hardware sharing. Therefore, if the hyperelliptic-curve cryptography processor is employed in mobile devices such as a cellular phone, a PDA and a smart card where resources and power consumption are critical constraints, a more effective user authentication, key distribution, signature, encryption and decryption can be provided.

Second, the hyperelliptic-curve cryptography processor provides a faster operational speed and higher level of security than RSA, i.e., a conventional public key cryptographic scheme, with a shorter key length. Further, a genus one elliptic-curve cryptography algorithm can be also performed in the hyperelliptic-curve cryptography processor.

Third, the hyperelliptic-curve cryptography processor can be effectively used in large-scale security systems demanding high speed processing of large amount of public key cryptography algorithm, wherein the security systems include an e-commerce server, a security router, a security gateway and a key distribution center.

While the invention has been shown and described with respect to the preferred embodiments, it will be understood by those skilled in the art that various changes and modifications may be made without departing from the spirit and scope of the invention as defined in the following claims.

What is claimed is:

1. An apparatus for a hyperelliptic-curve cryptography processing, comprising:
an input/output control block for controlling a peripheral component interconnect (PCI) interface block, a direct memory access (DMA) and data input/output;
an input memory block for storing external instructions and input data provided by the PCI interface block;
an output memory block for storing a final and an intermediate value of a hyperelliptic-curve cryptography operation;
a MUX for controlling a path of input/output data of the input and the output memory block;
an operation core block for performing a genus one elliptic-curve cryptography algorithm and the genus two hyperelliptic-curve cryptography algorithm depending on the external instructions and the input data provided by the MUX; and
a means for controlling the operation core block according to instructions transmitted from the input memory block.

2. The apparatus of claim 1, wherein the operation core block includes:
a field and a ring operation unit for performing multiplication, squaring, addition and subtraction;
a Jacobian operation control unit for controlling a divisor operation of the field and the ring operation unit;
a register file for storing input data to be processed and an intermediate data of the operations; and
an interconnection network for interconnecting the field and the ring operation unit, the Jacobian operation control unit and the register file.

3. The apparatus of claim 2, wherein the field operation unit includes:
an addition and subtraction block;
a multiplication-reduction block;
an inverse and greatest common divisor (GCD) computation block; and
a squaring-reduction block, and wherein the ring operation unit further includes a division block.

4. The apparatus of claim 3, wherein the addition and subtraction block, the multiplication-reduction block, the inverse and GCD computation block, the squaring-reduction block and the division block are respectively shared for the field operation and the ring operation, and an input data type of the field operation unit and the ring operation unit is a bit stream and a field element, respectively.

5. The apparatus of claim 2, wherein the operation core block performs an inverse computation in the field operation and a GCD computation in the ring operation respectively by using an extended Euclidian algorithm (EEA).

6. The apparatus of claim 3, wherein the inverse and GCD computation, the multiplication-reduction and the squaring-reduction operation are performed by using operation equations, i.e., ‘(A+B)<<C’ and ‘A+(B<<C)’, wherein the operation equations are implemented by an XOR block, a barrel shifter block, a shifter controller and a data path control MUX.

7. The apparatus of claim 4, wherein the inverse and GCD computation, the multiplication-reduction and the squaring-reduction operation are performed by using operation equations, i.e., ‘(A+B)<<C’ and ‘A+(B<<C)’, wherein the operation equations are implemented by an XOR block, a barrel shifter block, a shifter controller and a data path control MUX.

8. The apparatus of claim 5, wherein the inverse and GCD computation, the multiplication-reduction and the squaring-reduction operation are performed by using operation equations, i.e., ‘(A+B)<<C’ and ‘A+(B<<C)’, wherein the operation equations are implemented by an XOR block, a barrel shifter block, a shifter controller and a data path control MUX.

9. The apparatus of claim 6, wherein the inverse and GCD computation, the multiplication-reduction and the squaring-reduction are processed in parallel for a comparison and specific functional operations thereof respectively.

10. The apparatus of claim 7, wherein the inverse and GCD computation, the multiplication-reduction and the squaring-reduction are processed in parallel for a comparison and specific functional operations thereof respectively.

11. The apparatus of claim 8, wherein the inverse and GCD computation, the multiplication-reduction and the squaring-reduction are processed in parallel for a comparison and specific functional operations thereof respectively.

12. The apparatus of claim 3, wherein the hyperelliptic-curve cryptography processing apparatus further includes pipeline registers placed in the inverse and GCD computation block and a division block.

13. The apparatus of claim 4, wherein the hyperelliptic-curve cryptography processing apparatus further includes pipeline registers placed in the inverse and GCD computation block and a division block.

14. The apparatus of claim 5, wherein the hyperelliptic-curve cryptography processing apparatus further includes pipeline registers placed in the inverse and GCD computation block and a division block.

15. The apparatus of claim 12, wherein the inverse and GCD computation block and the division block process a Jacobian addition and doubling in parallel in order to process a scalar multiplication required for the hyperelliptic-curve cryptography processing.

16. The apparatus of claim 13, wherein the inverse and GCD computation block and the division block process a Jacobian addition and doubling in parallel in order to process a scalar multiplication required for the hyperelliptic-curve cryptography processing.

17. The apparatus of claim 14, wherein the inverse and GCD computation block and the division block process a Jacobian addition and doubling in parallel in order to process a scalar multiplication required for the hyperelliptic-curve cryptography processing.
